(19) United States
(12) Patent Application Publication
(10) Pub. No.: US 2008/0117923 A1
(43) Pub. Date: May 22, 2008

(54) Method for Routing Internet Connections Via Network Gateways

(75) Inventor: Gerhard Otte, Wolfratshausen (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/883,511

(22) PCT Filed: Sep. 9, 2005
(86) PCT No.: PCT/EP05/54476

§ 371 Date: Aug. 1, 2007

(30) Foreign Application Priority Data
Feb. 3, 2005 (DE) 10 2005 005 083.2

(51) Int. Cl. H04L 12/28

(52) U.S. Cl. 370/401

(57) ABSTRACT

For users of a private network to be able to communicate with users of a public network, the private IP addresses must be converted into a network-wide globally acceptable IP address at the network gateway. All users of the private network thus obtain a single IP address in the public global network. The above is an unambiguous condition that the user belongs to the private network. Where several network gateways are present the users of the same private network are allocated several IP addresses. To indicate that the user belongs to the same private network, in this case additional information is provided, specific to the private network, by which the identification may be made at any time on the public global network.

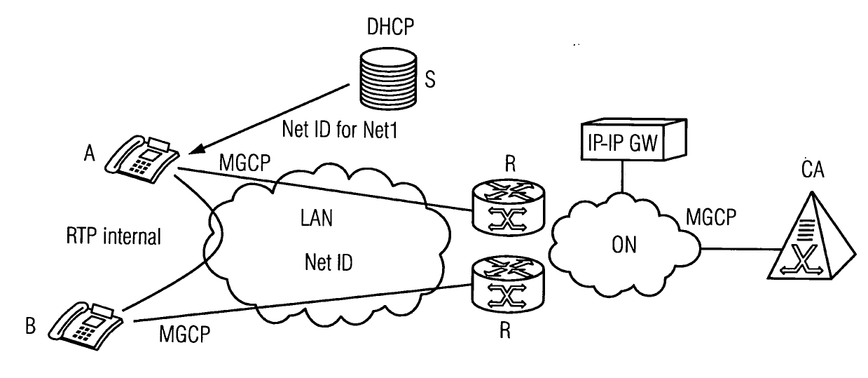

### CROSS REFERENCE TO RELATED APPLICATIONS

This application is based on and hereby claims priority to German Application No. 10 2005 005 083.2 filed on Feb. 3, 2005, the contents of which are hereby incorporated by reference.

### BACKGROUND

In the internet world, IP (Internet Protocol) addresses are limited and expensive. The limitation is due to the fact that an IP address must be unique worldwide in the public network. Private IP addresses, on the other hand, are only used locally, i.e. in the LAN (Local Area Network) area, for example, and have no effect globally. Private IP addresses therefore only need to be unique in the LAN area.

To enable LAN users to communicate with public users, the private IP address must be translated into a network-unique (global) IP address at the gateway between LAN and public network. This is generally performed using Network Address Translation (NAT) or Network Address Port Translation (NAPT) functionality. The NAT function is a protocol describing the translation of IP addresses from one network to another and is used on routers or firewalls. Using the NAT function, for example, a network address 10.0.0.2 can be converted to 192.168.0.2, another IP address 10.0.0.3 to 192.168.0.3, etc. With NAPT it is analogously possible to translate port numbers.

The most frequent application of NAT functionality is for connecting a local area network (i.e. the IP addresses of all the machines in a network) to a public network via a single official IP address, often via a firewall. This allows the IP addresses of individual or a plurality of networks to be concealed (masquerading), which means that a private network is represented to the outside world by a single IP address.

NAT functionality enables the ever diminishing number of public IP addresses to be augmented by additional (private) IP addresses. NAT functionality is also conducive to data security, as the internal structure of the network remains hidden to the outside world (security aspect).

Masking of IP addresses is now causing problems in many areas. Particularly in VoIP signaling via MGCP/Megaco/SIP it is necessary to detect (security, bandwidth, etc.) that users are located in the same network segment. Only if this is the case can data streams (RTP) be routed exclusively in that segment and remain invisible to the outside world.

For this reason there exist, in the related art, application layer gateways (NAT traversal devices) which provide elegant solutions here (particularly for remote access).

The problem with these related art solutions is that users are assigned to a network segment exclusively via the IP address (official IP address) of the network gateway (firewall). This means that the users of the local area network all have the same IP address in the public network. If only one network gateway exists (e.g. via a single router/firewall), the (application layer) gateway detects that all the users with the same IP address (and possibly different port numbers) belong to the same network. However, a single network gateway poses the risk of a bottleneck, i.e. all local area network users communicate with public network users via this network gateway. Dynamics problems are therefore bound to arise.

For this reason a plurality of network gateways is generally provided. This means that it is no longer possible to assign users to a network segment, as all the network gateways are assigned different IP addresses. As the IP address is the sole criterion for the (application layer) gateway, the local area network users are in this case interpreted as users of different networks. In the event that users connect to the public network via different network cards of a firewall or of a plurality of firewalls, this assignment is lost.

If the (application layer) gateway detects a single IP address for two local area network users, the RTP data stream is routed locally. If the gateway detects two IP addresses, the RTP data stream is routed globally, i.e. across the network gateway. Consequently, if a plurality of network gateways are present, data streams can no longer be kept local, even if the users are located within a routable network segment.

### SUMMARY

An aspect is to unambiguously identify networks across network gateways.

The essential aspect is that additional information is introduced which makes the assignment of users to a network segment unambiguously identifiable. For this purpose the users are advised of a network identification number (NetID).that is common to all the users within a routable network segment. A downstream instance (NAT traversal, softswitch, etc.) can therefore detect whether a data connection can take place directly between two communication points (peer-to-peer).

The network identification number (NetID) can be part of a user-specific field within the message, or even be introduced as a naming convention (e.g. userI@netID.siemens.de). The network identification number can be administered via the Dynamic Host Configuration Protocol (DHCP) process, which means that all the users are informed of this NetID at start-up. This information is transmitted accordingly along with the signaling, and is interpreted by the signaling end points.

### BRIEF DESCRIPTION OF THE DRAWINGS

These and other objects and advantages will become more apparent and more readily appreciated from the following description of an exemplary embodiment taken in conjunction with the accompanying drawing.

The drawing is a block diagram of a local area network connected to a public network.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

A public network ON is shown which is operatively connected to a local area network LAN via two routers R. One router R is disposed in each network gateway. The two user terminals A, B are to be considered as part of the local area network LAN. The signaling information of the two user terminals A, B is fed via an MGCP (Media Gateway Control Protocol) to a call agent CA disposed in the public network. The private IP addresses in the LAN network, as well as the network identification number NetID, are assigned to the terminals by a server S as part of the DHCP process. The server S is therefore also responsible for assigning the network identification number NetID which is valid for all the users of the local area network. Finally a gateway IP-IP GW is incorporated into the public network ON. Translation of the private IP addresses to global IP addresses is performed in the routers R.

It will now be assumed that a voice carrier offers an MGCP-based VoIP service for the LAN customers, the voice datastream RTP being intended to be routed where possible within the local area network for local calls. All the local area network users receive from the server S both local IP addresses and a network identification number NetID. User A subsequently wishes to set up a VoIP connection to user B. User A transfers in an MGCP message the private IP address together with the network identification number NetID to the call agent CA and the gateway IP-IP GW. In the router R, the NAT function is executed which translates the private IP addresses into a public IP address.

As a plurality of network gateways are present, a plurality of public IP addresses are also assigned to the LAN network users. The gateway IP-IP GW can therefore no longer detect, solely on the basis of the IP address as a criterion, that for a VoIP connection an internal RTP connection can be created between the two user terminals A, B of the local area network LAN.

Using the additional information supplied, which is implemented as a network identification number NetID, the gateway IP-IP GW detects that the two user terminals A, B are located in the same IP network and creates in the local area network the RTP connection between the two user terminals A, B.

The advantage of this approach is that the network identification number NetID is included in the payload of the IP packets (Layer 2) and evaluation therefore takes place in the gateway IP-IP GW at application level.

Although the description above refers to the MGCP protocol, there is no limitation to the MGCP protocol, and any other protocol such as the MEGACO or SIP protocol can be used. In addition, there is no limitation to VoIP as RTP, and other data connections likewise can be executed.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A method for identifying networks across at least one network gateway disposed between a first network and a second network, comprising:
providing additional information, unique to the first network, via which the first network is unambiguously identifiable in the second network.

11. The method as claimed in claim 10, further comprising:
receiving the additional information via the at least one network gateway at the second network; and
controlling communication between at least two users of at least the first network from the second network in accordance with the additional information.

12. The method as claimed in claim 11, wherein said controlling of communication between the at least two users is accomplished via a gateway disposed in the second network.

13. The method as claimed in claim 12, further comprising creating the additional information by a Dynamic Host Configuration Protocol server.

14. The method as claimed in claim 13, further comprising directly creating a bearer connection within the first network, if the at least two users are disposed in the first network.

15. A method as claimed in claim 14, wherein the additional information is included in a transmission protocol.

16. The method as claimed in claim 15, wherein said providing includes providing a network identification number that is part of a user-specific field within a protocol message.

17. The method as claimed in claim 15, wherein the network identification number is implemented as a naming convention.

18. A system in a first network for routing internet connections via a network gateway in a second network, comprising:
a gateway controlling communication between at least two users of the second network in accordance with additional information that is unique to the second network.

19. The system as claimed in claim 18, further comprising a Dynamic Host Configuration Protocol server creating the additional information.

20. The system as claimed in claim 19, wherein said Dynamic Host Configuration Protocol server provides a network identification number that is part of a user-specific field within a protocol message.

21. The system as claimed in claim 19, wherein the network identification number is implemented as a naming convention.
